(19) United States
(12) Patent Application Publication
(10) Pub. No.: US 2025/0377833 A1
(43) Pub. Date: Dec. 11, 2025

(54) WRITE BUFFER MANAGEMENT FOR A MEMORY SYSTEM

(71) Applicant: Micron Technology, Inc., Boise, ID (US)

(72) Inventors: Chaohui Liu, Shanghai (CN); Ming Ma, Shanghai (CN)

(21) Appl. No.: 19/222,866

(22) Filed: May 29, 2025

Related U.S. Application Data
(60) Provisional application No. 63/658,598, filed on Jun. 11, 2024.

(51) Int. Cl. G06F 3/06

(52) U.S. Cl. CPC G06F 3/0659; G06F 3/0613; G06F 3/0644; G06F 3/0683

(57) ABSTRACT

Methods, systems, and devices for write buffer management for a memory system are described. The described techniques provide for a memory system to receive data associated with multiple applications being executed concurrently and store the data to portions of a write buffer according to whether the data is sequential or non-sequential. For example, the memory system may receive sequential data for a first application between receiving non-sequential data for one or more second applications, and may partition a write buffer such that the sequential data is stored (e.g., sequentially) within a portion the write buffer and the non-sequential data is stored within a different portion of the write buffer. The memory system may flush portions of the write buffer to multiple-level memory cells once a portion is full, thereby storing sequential data to sequential physical addresses within the memory system.

### CROSS REFERENCE

The present Application for Patent claims priority to U.S. Patent Application No. 63/658,598 by Liu et al., entitled “WRITE BUFFER MANAGEMENT FOR A MEMORY SYSTEM,” filed Jun. 11, 2024, which is assigned to the assignee hereof, and which is expressly incorporated by reference in its entirety herein.

### TECHNICAL FIELD

The following relates to one or more systems for memory, including write buffer management for a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports write buffer management for a memory system in accordance with examples as disclosed herein.

FIG. 2 shows an example of a data storage scheme that supports write buffer management for a memory system in accordance with examples as disclosed herein.

FIG. 3 shows an example of a process that supports write buffer management for a memory system in accordance with examples as disclosed herein.

FIG. 4 shows a block diagram of a memory system that supports write buffer management for a memory system in accordance with examples as disclosed herein.

FIG. 5 shows a flowchart illustrating a method or methods that support write buffer management for a memory system in accordance with examples as disclosed herein.

### DETAILED DESCRIPTION

Some memory systems may support procedures or operations for storing data to one or more memory devices of the memory system. For example, the memory system may receive data (e.g., a data stream) to be written to one or more memory cells of a memory device. In some cases, the data stream may include data associated with one or multiple applications. As an example, the data stream may include first data associated with a first application and second data associated with a second application. In some cases, the first data may be sequential data (e.g., a set of data associated with a consecutive set of logical addresses) and the second data may be non-sequential data (e.g., random data, data otherwise associated with non-consecutive logical addresses).

In some instances, the sequential data may be interleaved with the non-sequential data such that the memory device may receive one or more portions of the non-sequential data between receiving one or more portions of the sequential data. However, storing such data may impact the performance of the memory device. For example, the memory device may perform one or more memory management operations (e.g., garbage collection operations) to reorganize the data such that the sequential data is stored to sequential physical addresses of the memory device, which may increase write amplification in the memory system (e.g., due to performing multiple write operations on the same information), among other disadvantages.

To support concurrently executing multiple applications while maintaining sequential data storage, a memory system may partition a write buffer into multiple segments (e.g., portions) associated with respective sets (e.g., ranges) of logical addresses and one or more segments associated with random data (e.g., data associated with non-sequential logical addresses). For example, the memory system may store received data (e.g., via a data stream) to a segment of a write buffer (e.g., a buffer including a set of single-level memory cells (SLCs) or another type of memory or memory cells) according to an indication of whether the data is sequential data or non-sequential data. In some cases, a system, such as a host system, may indicate whether incoming data is part of a sequential write operation or a random write operation via a field in a corresponding write command (e.g., an indication of one or more bits).

The memory system may identify whether the data is sequential or non-sequential, for example, according to the field in the write command, and may store the data to the write buffer according to the status of the data (e.g., whether the data is sequential or non-sequential). For example, if the data is part of a sequential write operation, the memory system may identify a logical address (or a range of logical addresses) associated with the data and may store the data to a segment of the write buffer corresponding to the logical address (or range of logical addresses). Alternatively, if the data is part of a non-sequential write operation (e.g., a random write operation), the memory system may store the data to the segment of the write buffer dedicated to storing random data.

In some examples, if a segment of the write buffer is full, the memory system may transfer (e.g., as part of a flushing operation) the data stored to the segment to a set of multiple-level memory cells, such as triple-level memory cells (TLCs) (e.g., leveraging relatively higher storage capacity). Accordingly, the memory system may transfer sequential data from the write buffer to sequential physical addresses in TLC memory and may transfer random data to a different set of physical addresses in the TLC memory, thereby enabling the memory system to concurrently execute multiple applications without adversely impacting data storage techniques. Such techniques may also mitigate write amplification, which may otherwise occur, by storing data to the TLC memory.

In addition to applicability in memory systems as described herein, techniques for write buffer management at a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by supporting sequential data storage while executing multiple applications or tasks simultaneously, which may decrease a frequency of memory management operations to reorganize data, among other benefits.

In addition to applicability in memory systems as described herein, techniques for write buffer management at a memory system may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, capacity, and processing power of edge devices may decrease a reliance on the devices to remote computing devices, which may otherwise increase latency of operations performed at the devices. Implementing the techniques described herein may support edge computing techniques by mitigating a quantity of memory management operations associated with transferring data within a memory device, among other benefits.

Features of the disclosure are illustrated and described in the context of systems, devices, and circuits. Features of the disclosure are further illustrated and described in the context of a data storage scheme, a process, and flowcharts.

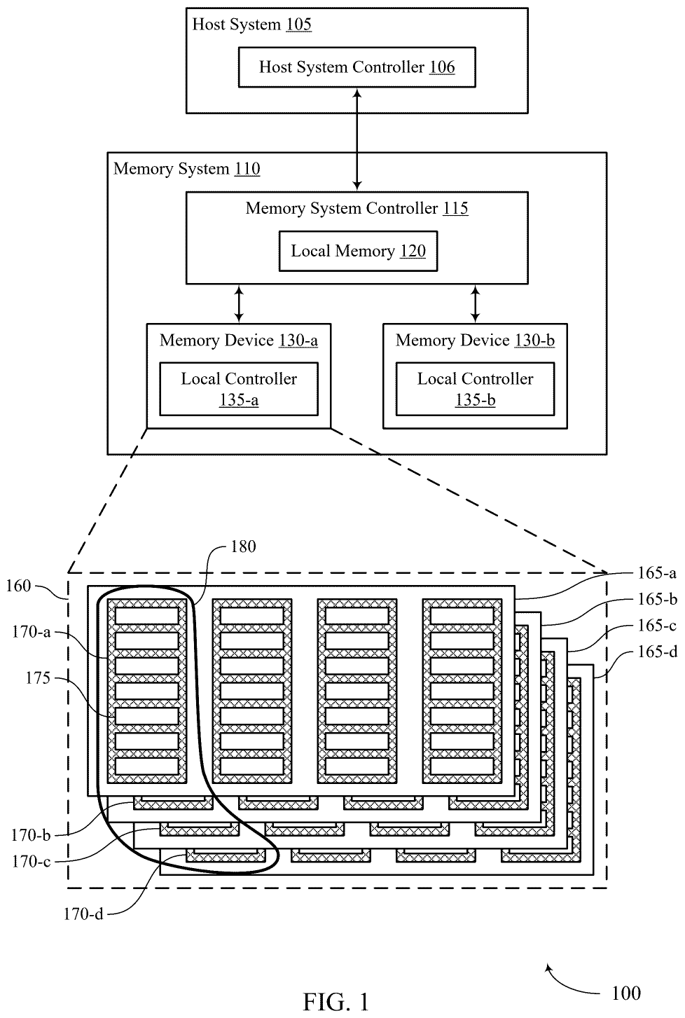

FIG. 1 shows an example of a system 100 that supports write buffer management for a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as SLCs. Additionally, or alternatively, a NAND memory device 130 may include memory cells configured to each store multiple bits of information, which may be referred to as multi-level cells (MLCs) if configured to each store two bits of information, as TLCs if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support write buffer management for a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples of the system 100, the memory system 110 may be configured to store data associated with multiple applications. For example, the system 100 may support an operating system (OS) capable of multitasking (e.g., a Linux kernel OS) such that multiple tasks may be executed concurrently by the host system 105 and the memory system 110 (which may be an example of a universal flash storage (UFS) device). The host system 105 may issue one or more write commands indicating data associated with one or more applications and may transmit a data stream to the memory system 110 including the data associated with the one or more applications. In some examples, a first write command may indicate to write a set of sequential data (e.g., data having contiguous logical addresses) and a second write command may indicate to write a set of non-sequential or random data (e.g., data having non-contiguous logical addresses).

For example, the host system 105 may transmit the data stream to the memory system 110 including sequential data associated with a first application (e.g., a user application) and including non-sequential data associated with one or more second applications (e.g., a kernel thread performing random writes according to an interval). However, the data stream may include the non-sequential data between portions of sequential data (e.g., if a random write occurs while executing the sequential write operation), which may result in the memory system 110 storing sequential data at non-sequential physical addresses of a memory device 130. In such examples, the memory system 110 may perform one or more memory management operations, such as garbage collection, to reorganize the data such that sequential data is stored contiguously, which may increase a write amplification associated with the memory system 110 (e.g., thereby degrading a performance of the memory system 110).

In some cases, to support concurrently executing multiple applications while maintaining sequential data storage, the memory system 110 may partition a write buffer into multiple segments associated with respective sets of logical addresses, and an additional segment (or segments) associated with to random data (e.g., non-sequential logical addresses). For example, the memory system 110 (e.g., a UFS device supporting turbo write operations) may utilize a write buffer of a memory device 130 (e.g., a buffer included in the local memory 120, which may be an example of a set of SLCs) to store received data (e.g., via a data stream), and may store the data to a segment of the write buffer according to an indication of whether the data is sequential data or non-sequential data. In some cases, the host system 105 may indicate whether incoming data is part of a sequential write operation or a random write operation via a field in a corresponding write command (e.g., an indication of one or more bits).

The memory system 110 may identify whether the data is sequential or non-sequential according to the field in the write command, and may store the data to the write buffer according to the status of the data. For example, if the data is part of a sequential write operation, the memory system 110 may identify a logical address associated with the data and may store the data to a segment of the write buffer corresponding to the logical address. Alternatively, if the data is part of a non-sequential write operation, the memory system 110 may store the data to the segment of the write buffer dedicated to storing random data. In some examples, if a segment of the write buffer is full, the memory system 110 may transfer (e.g., as part of a flushing operation) the data stored to the segment to a set of multiple-level memory cells, such as TLCs (e.g., leveraging relatively higher storage capacity). Accordingly, the memory system 110 may transfer sequential data from the write buffer to sequential physical addresses in TLC memory and may transfer random data to a different set of physical addresses in the TLC memory, thereby enabling the memory system 110 to concurrently execute multiple applications without adversely impacting data storage operations. Such techniques may mitigate write amplification, which may otherwise occur, by storing data to the TLC memory.

The system 100 may include any quantity of non-transitory computer readable media that support write buffer management for a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

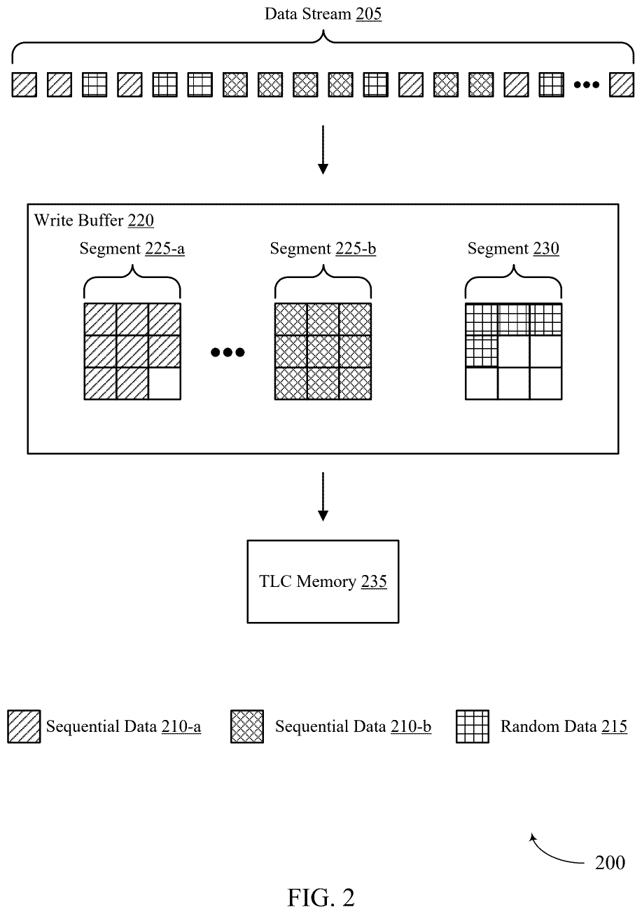

FIG. 2 shows an example of a data storage scheme 200 that supports write buffer management for a memory system in accordance with examples as disclosed herein. The data storage scheme 200 may implement, or be implemented by, one or more aspects of the system 100. For example, the data storage scheme 200 depicts an example of a memory system storing received data to a write buffer, which may be an example of a local memory 120 described with reference to FIG. 1. Additionally, or alternatively, data may be flushed from the write buffer to one or more TLCs, which may be included in a memory device 130 as described with reference to FIG. 1. In some cases, the data storage scheme 200 may support the memory system concurrently executing multiple applications while retaining sequential storage addressing for sequential data, which may improve the overall performance of the memory system.

In some examples, the memory system may receive a data stream 205 that includes data associated with multiple applications (e.g., tasks, operations). For example, the memory system may receive a first write command associated with a set of sequential data 210-a (e.g., associated with a first application), a second write command associated with a set of sequential data 210-b (e.g., associated with a second application), and one or more third write commands associated with one or more portions of random data 215 (e.g., associated with one or more third applications).

In some cases, the memory system may support executing the first application, the second application, and the one or more third applications concurrently. Accordingly, a host system may transmit the data stream 205 including the sequential data 210-a, the sequential data 210-b, and the random data 215 based on a time each application is executed (e.g., in a chronological order). That is, the memory system may receive portions of the random data 215 between receiving portions of the sequential data 210-a and the sequential data 210-b (e.g., if a random write is executed at certain intervals while the host device transmits sequential data to the memory system). Similarly, the memory system may receive portions of the sequential data 210-b between receiving portions of the sequential data 210-b, or vice-versa.

The memory system may be configured to store data (e.g., received via the data stream 205) in a write buffer 220, which may include one or more SLCs (e.g., if the memory system is a UFS device supporting turbo write operations). In some cases, storing the data to the write buffer 220 in an order that the data is received via the data stream 205 may result in the memory system storing the random data 215 between portions of the sequential data 210-a, the sequential data 210-b, or both. Additionally, or alternatively, the memory system may store portions of the sequential data 210-a between portions of the sequential data 210-b, or vice-versa, thereby resulting in the write buffer 220 containing non-sequential data. In some examples, the memory system may perform one or more memory management operations (e.g., garbage collection operations) to reorganize the data such that the sequential data 210-a and the sequential data 210-b are each stored sequentially (e.g., each set of sequential data 210 stored in consecutive addresses of the write buffer 220). However, such memory management operations may increase a write amplification of the memory system (e.g., due to writing the same information multiple times), which may increase a wear on the write buffer 220 and introduce additional latency to the memory system, among other adverse effects.

To mitigate a quantity of memory management operations performed on memory cells of the write buffer 220, the memory system may partition the write buffer 220 into multiple segments 225 associated with respective sets of logical addresses for storing sequential data 210, and an additional segment 230 (or segments 230) dedicated to storing random data 215. For example, the memory system may designate each of the segments 225 to store respective sets of contiguous logical addresses, such as a first segment 225-a configured to store a first set of contiguous logical addresses and a second segment 225-b configured to store a second set of contiguous logical addresses. In some cases, the memory system may designate a quantity of segments 225 to store sequential logical addresses such that each logical address of the memory system is associated with a segment 225.

For example, the first set of contiguous logical addresses associated with the segment 225-a may correspond to an initial set of logical addresses of a memory device (e.g., logical addresses 0 through k) and the second set of contiguous logical addresses associated with the segment 225-b may correspond to a final set of logical addresses of the memory device (e.g., logical addresses N-k through N, where the memory device supports N total logical addresses). It should be noted that the write buffer 220 may include any quantity of segments 225 in between the segment 225-a and the segment 225-b (e.g., the memory device may support storing any quantity of logical addresses). Additionally, the memory system may designate a segment 230 or segments 230 (e.g., in addition to the segments 225) to store random logical addresses, such as the logical addresses associated with the random data 215. As used herein, random logical addresses may refer to any two or more logical addresses that are non-contiguous (e.g., non-sequential).

In some cases, the memory system may identify whether incoming data (e.g., a portion of data at the head of the data stream 205) is associated with sequential data 210 or random data 215 according to an indication in a write command associated with the incoming data. For example, a host system may transmit a write request command to the memory system indicating to write the sequential data 210-a to a memory device, and may indicate (e.g., mark) that the data is sequential in a field of the write request command (e.g., via a bit indication). Similarly, the host system may indicate that the sequential data 210-b is sequential in a field of a second write request command indicating the sequential data 210-b. In some cases, the host system may refrain from setting the indication in write request commands associated with the random data 215, or may set a bit associated with the write command to a value indicating that the data is random.

The memory system may store incoming data to portions of the write buffer 220 according to the indication of whether the data is sequential and, if the data is sequential, a logical address associated with the data. For example, the memory system may receive a portion of the sequential data 210-a, may identify that the portion is part of a sequential write operation (e.g., according to the bit indication in the corresponding write request command or included with the portion of the sequential data 210-a), and may identify a logical address associated with the portion of the sequential data 210-a (e.g., according to logical addresses indicated in the corresponding write command). The memory system may store the portion of the sequential data 210-a to a segment 225 of the write buffer that includes the logical address associated with the portion of the sequential data 210-a.

For example, the memory system may identify that the portion of the sequential data 210-a corresponds to a logical address included in the segment 225-a (e.g., a logical address between 0 and k), and the memory system may store the portion of the sequential data 210-a to the segment 225-a. The memory system may perform similar operations to store the sequential data 210-b, such that the sequential data 210-a and the sequential data 210-b are stored to contiguous portions (e.g., segments 225) of the write buffer 220. Additionally, the memory system may receive a portion of the random data 215 (e.g., between receiving portions of the sequential data 210-a or the sequential data 210-b), may identify that the portion is not associated with sequential data, and may store the portion of the random data 215 to the segment 230 based on (e.g., in response to) designating the segment 230 to store the random data 215.

In some cases, the memory system may transfer data stored to the write buffer 220 to a set of multiple-level memory cells, such as a set of TLCs, during an operation subsequent to receiving the write command(s) (e.g., a flushing operation, a folding operation). For example, the memory system may transfer data stored to a segment 225 or the segment 230 of the write buffer 220 to TLC memory 235 of a memory device (e.g., to leverage relatively higher storage capacity) if a quantity of data stored to a respective segment satisfies a threshold value. In some cases, the threshold value may correspond to a storage capacity of a corresponding segment of the write buffer. That is, each of the segments 225 and the segment 230 may be configured to store the threshold quantity of data (e.g., k logical addresses or respective quantities of logical addresses).

As an example, the memory system may store portions of the sequential data 210-a to the segment 225-a based on (e.g., in response to) logical addresses associated with the portions of the sequential data 210-a corresponding to logical addresses associated with the segment 225-a. In some cases, if the quantity of data stored to the segment 225-a does not satisfy the threshold value (e.g., the segment 225-a is not full, as illustrated in FIG. 2), the memory system may refrain from transferring the sequential data 210-a to the TLC memory 235 until the segment 225-a is full.

Additionally, or alternatively, the memory system may store portions of the sequential data 210-b to the segment 225-b based on (e.g., in response to) logical addresses associated with the portions of the sequential data 210-b corresponding to logical addresses associated with the segment 225-b. In some examples, if the memory system stores a portion of the sequential data 210-b to the segment 225-b such that the segment 225-b stores the threshold quantity of data (e.g., the segment 225-b is full, as illustrated in FIG. 2), the memory system may transfer the sequential data 210-b to the TLC memory 235. For example, the memory system may transfer the sequential data 210-b stored to the segment 225-b to sequential physical addresses in the TLC memory 235. The memory system may perform similar operations for each segment 225 and the segment 230 once the corresponding segment is full (e.g., flushing the segment to the TLC memory 235). Accordingly, the memory system may store sequential data to sequential physical addresses in the TLC memory 235 in a single operation (e.g., a single flushing operation), thereby improving a performance of the memory system storing data to the TLC memory 235 (e.g., by reducing write amplification associated with flushing data to the TLC memory 235).

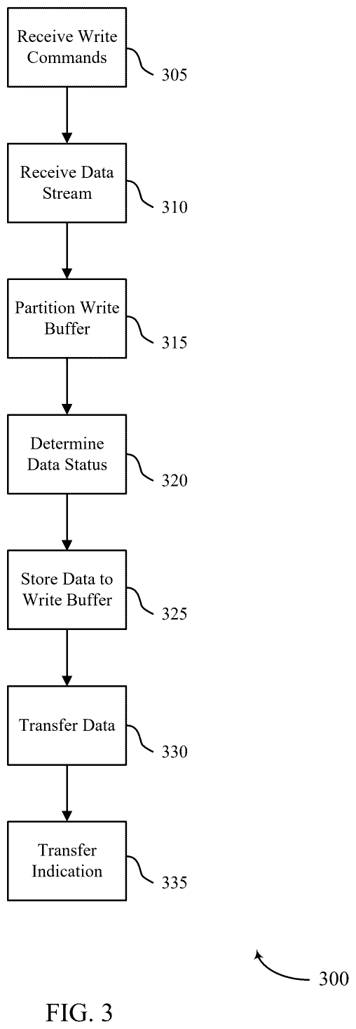

FIG. 3 shows an example of a process 300 that supports write buffer management for a memory system in accordance with examples as disclosed herein. The process 300 may implement, or be implemented by, one or more aspects of the system 100 and the data storage scheme 200. For example, the process 300 may include signaling and operations performed by a memory system, which may be an example of corresponding devices described with reference to FIGS. 1 and 2. In some cases, the process 300 may support the memory system receiving data associated with multiple applications executed concurrently and storing data sequentially based on (e.g., in response to) partitioning a write buffer, which may be examples of techniques described with reference to FIG. 2. Alternative examples may be implemented, where some processes are performed in a different order than described or are not performed. In some cases, processes may include additional features not mentioned below, or further processes may be added.

At 305, one or more write request commands may be transmitted. For example, a host system may transmit (e.g., send, issue) one or more write request commands to the memory system. In some instances, the one or more write request commands may indicate data associated with one or more applications (e.g., tasks). For example, the memory system may receive a first write command indicating first data to be stored to the memory system, a second write command indicating second data to be stored to the memory system, one or more third write commands indicating third data to be stored to the memory system, or any combination thereof.

In some examples, each write command may be associated with a respective application being executed concurrently by the host system. For example, the first data may be associated with a first application, the second data may be associated with a second application different than the first application, and the third data may be associated with one or more third applications different than the first application and the second application, where the first application, second application, and one or more third applications are executed concurrently (e.g., simultaneously, in overlapping time domain intervals, or the like).

At 310, a data stream may be transmitted. In some examples, the host system may transmit a data stream. For example, the host system may transmit the data stream to the memory system, and the data stream may include the first data, the second data, and the third data (e.g., based on receiving the write commands, in response to receiving the write commands). In some examples, the data stream may include portions of the first data, the second data, and the third data according to an order that applications associated with each set of data are executed. For example, due to the first application, second application, and one or more third applications being executed concurrently, the data stream may include the first data, the second data, and the third data in non-sequential portions (e.g., despite the first data and the second data being sequential). In other words, the memory system may receive portions of the third data between portions of the first data and portions of the second data, or vice-versa, as illustrated in FIG. 2.

At 315, a write buffer may be partitioned. In some examples, the memory system may partition the write buffer. For example, the memory system may partition the write buffer into multiple portions (e.g., segments) to support storing the first data, the second data, and the third data to the write buffer. In some examples, such as if the memory system supports turbo write operations (e.g., if the memory system is a UFS device), the write buffer may include a set of multiple SLCs (e.g., storing incoming write data to leverage relatively quicker access speeds associated with SLCs). The memory system may partition the write buffer such that a set portions of the write buffer are associated with respective sets of sequential (e.g., consecutive, contiguous) logical addresses and an additional portion of the write buffer is associated with non-consecutive logical addresses. For example, the memory system may designate a first portion of the write buffer to be associated with a first set of sequential logical addresses, may designate a second portion of the write buffer to be associated with a second set of sequential logical addresses, and may designate a third portion of the write buffer to be associated with non-sequential logical addresses (e.g., the third portion may store any logical address associated with random data). In some cases, a quantity of the portions associated with the respective sets of logical addresses may correspond to a total quantity of logical addresses supported by the memory system. In some cases, each portion of the write buffer may be configured to include a same quantity of logical addresses or different quantities of logical addresses.

At 320, a status of data may be determined. In some examples, the memory system may determine a status of data. For example, the memory system may determine whether incoming data (e.g., received via the data stream) is part of a sequential write operation (e.g., data having contiguous logical addresses) or a non-sequential write operation (e.g., data associated with a random write). In some cases, the memory system may determine the status of the data according to an indication included in a corresponding write command. For example, the memory system may receive a portion of the first data and may identify that the first data includes sequential data based on (e.g., in response to) an indication in the first write command (e.g., a bit being set to a first value, such as binary ‘0’ or binary ‘1’). Similarly, the memory system may identify that the second data includes sequential data based on (e.g., in response to) an indication in the second write command (e.g., a bit being set to the first value) and may identify that the third data includes non-sequential data based on (e.g., in response to) respective indications in the one or more third write commands (e.g., respective bits being set to a second value different from the first value).

At 320, the received data may be stored to the write buffer. In some examples, the memory system may store the received data to the write buffer. For example, the memory system may store the data based on (e.g., in response to) partitioning the write buffer and determining the status of the data. The memory system may receive a portion of the first data and may store the portion of the first data to the first portion of the write buffer based on (e.g., in response to) identifying that the first data is sequential data (e.g., according to the bit indication in the first write command). In some cases, the first portion of the write buffer may be associated with a range of logical addresses that includes the logical addresses associated with the first data. As another example, the memory system may receive a portion of the second data and may store the portion of the second data to the second portion of the write buffer based on (e.g., in response to) identifying that the second data is sequential data (e.g., where the second portion of the write buffer may be associated with logical addresses corresponding to logical addresses associated with the second data). As another example, the memory system may receive a portion of the third data and may store the portion of the third data to the third portion of the write buffer based on (e.g., in response to) identifying that the third data is non-sequential data (e.g., due to the third portion of the write buffer being configured to store non-sequential logical addresses).

At 330, data may be transferred. In some examples, the memory system may transfer the data. For example, the memory system may transfer the data stored to the write buffer to an array of multiple-level memory cells, such as one or more TLCs (e.g., during a folding operation or a flushing operation to leverage relatively higher storage capacity). In some cases, the memory system may transfer data from a respective portion of the write buffer based on (e.g., in response to) a quantity of data stored to the portion satisfying a threshold value, which may correspond to a storage capacity of the portion of the write buffer (e.g., data stored to a portion of the write buffer is transferred once the portion is full). For example, the memory system may store a portion of the second data to the second portion of the write buffer (e.g., in accordance with operations at 325) and may identify, after storing the portion of the second data, that the quantity of data stored to the second portion of the write buffer satisfies the threshold value (e.g., the second portion of the write buffer is full). In such examples, the memory system may transfer, from the second portion of the write buffer, the second data to a first set of the multiple-level memory cells having sequential physical addresses.

In another example, the memory system may store a portion of the first data to the first portion of the write buffer and may identify, after storing the portion of the first data, that the quantity of data stored to the first portion of the write buffer does not satisfy the threshold value (e.g., the first portion of the write buffer is not full). In such examples, the memory system may refrain from transferring the data stored to the first portion of the write buffer until the quantity of data stored to the first portion satisfies the threshold value. For example, the memory system may transfer, from the first portion of the write buffer once the first portion is full, the first data to a second set of the multiple-level memory cells having sequential physical addresses. The memory system may perform similar techniques to transfer data stored to the third portion of the write buffer (e.g., random data), such that the third data is stored to a third set of multiple-level memory cells once the third portion of the write buffer is full.

At 335, an indication may be transmitted. In some examples, the memory system may transmit the indication to the host system. For example, the memory system may indicate that a portion of the write buffer has been flushed to the multiple-level memory cells (e.g., after the flushing operation is complete). In some cases, the memory system may transmit a respective indication after each successful flushing operation indicating the portion of the write buffer that has been flushed.

By storing data to portions of the write buffer according to the status of the data and logical addresses associated with the data, the memory system may support concurrent execution of multiple applications while retaining sequential storage in the write buffer, thereby reducing a quantity memory management operations performed by the memory system (e.g., garbage collection to reorganize data to be stored sequentially).

Aspects of the process 300 may be implemented by one or more controllers, among other components. Additionally, or alternatively, aspects of the process 300 may be implemented as instructions stored in one or more memories (e.g., firmware stored in one or more memories coupled with the memory system. For example, the instructions, when executed by one or more controllers (e.g., the memory system controller 115), may cause the one or more controllers (or a device or a system) to perform the operations of the process 300.

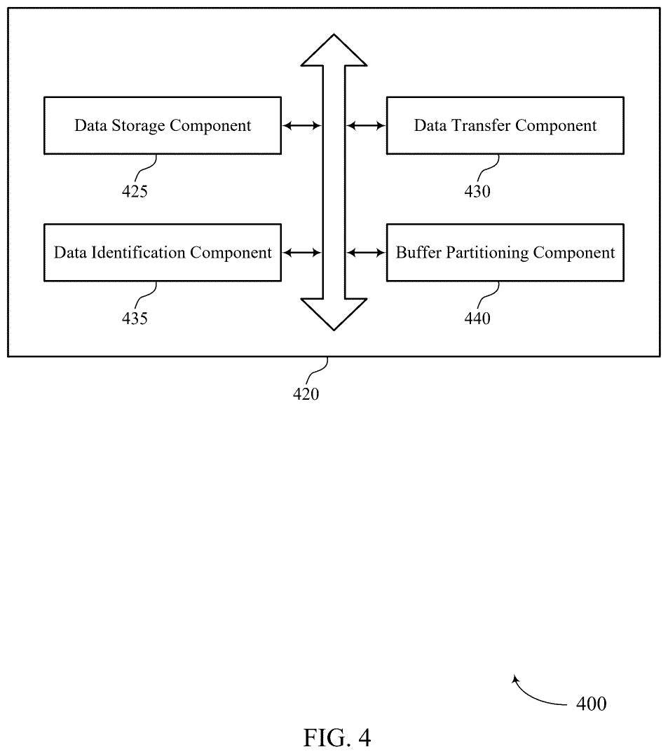

FIG. 4 shows a block diagram 400 of a memory system 420 that supports write buffer management for a memory system in accordance with examples as disclosed herein. The memory system 420 may be an example of aspects of a memory system as described with reference to FIGS. 1 through 3. The memory system 420, or various components thereof, may be an example of means for performing various aspects of write buffer management for a memory system as described herein. For example, the memory system 420 may include a data storage component 425, a data transfer component 430, a data identification component 435, a buffer partitioning component 440, or any combination thereof. Each of these components, or components of subcomponents thereof (e.g., one or more processors, one or more memories), may communicate, directly or indirectly, with one another (e.g., via one or more buses).

The data storage component 425 may be configured as or otherwise support a means for storing first data to a first portion of a write buffer of the memory system in response to receiving a first write command, where the write buffer includes the first portion that is associated with a first set of sequential logical addresses and a second portion that is associated with a second set of sequential logical addresses. In some examples, the data storage component 425 may be configured as or otherwise support a means for storing second data to the second portion of the write buffer in response to receiving a second write command. The data transfer component 430 may be configured as or otherwise support a means for transferring, from the second portion of the write buffer, the second data to a first set of multiple-level memory cells having sequential physical addresses in accordance with a quantity of data stored to the second portion of the write buffer satisfying a threshold value.

In some examples, the write buffer includes a third portion that is associated with a third set of random logical addresses, and the data storage component 425 may be configured as or otherwise support a means for storing third data to the third portion of the write buffer in response to receiving a third write command, where the third set of random logical addresses includes one or more non-sequential logical addresses.

In some examples, the buffer partitioning component 440 may be configured as or otherwise support a means for partitioning, by the memory system, the write buffer into a plurality of portions including at least the first portion, the second portion, and the third portion.

In some examples, the data transfer component 430 may be configured as or otherwise support a means for transferring, from the first portion of the write buffer, the first data to a second set of multiple-level memory cells having sequential physical addresses in accordance with a second quantity of data stored to the first portion of the write buffer satisfying the threshold value.

In some examples, the threshold value is associated with a storage capacity of the second portion of the write buffer.

In some examples, the data identification component 435 may be configured as or otherwise support a means for determining that the first data includes sequential data in response to receiving the first write command, where storing the first data to the first portion is in response to determining that the first data includes sequential data. In some examples, the data identification component 435 may be configured as or otherwise support a means for determining that the second data includes sequential data in response to receiving the second write command, where storing the second data to the second portion is in response to determining that the second data includes sequential data.

In some examples, determining that the first data includes sequential data is in accordance with the first write command including a bit indicating that the first data includes sequential data. In some examples, determining that the second data includes sequential data is in accordance with the second write command including a bit indicating that the second data includes sequential data.

In some examples, the first data is associated with a first application and the second data is associated with a second application different than the first application. In some examples, the first application and the second application are executed concurrently.

In some examples, the write buffer includes a plurality of single-level memory cells.

In some examples, the first set of multiple-level memory cells includes one or more triple-level memory cells.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

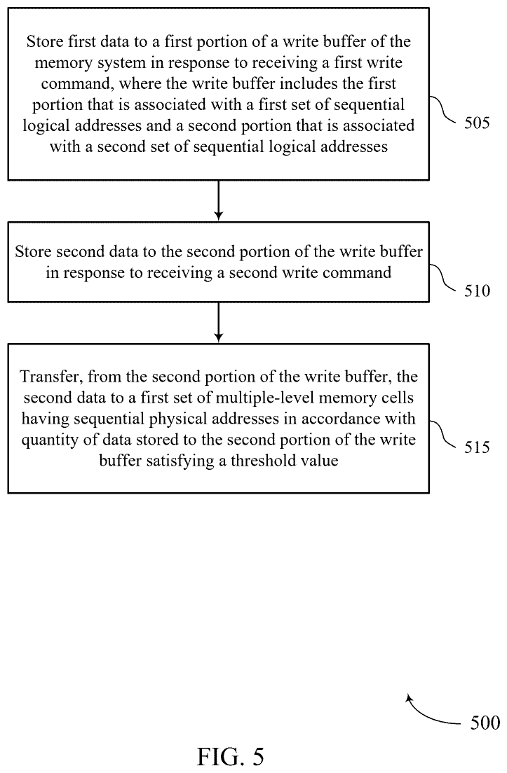

FIG. 5 shows a flowchart illustrating a method 500 that supports write buffer management for a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include storing first data to a first portion of a write buffer of the memory system in response to receiving a first write command, where the write buffer includes the first portion that is associated with a first set of sequential logical addresses and a second portion that is associated with a second set of sequential logical addresses. In some examples, aspects of the operations of 505 may be performed by a data storage component 425 as described with reference to FIG. 4.

At 510, the method may include storing second data to the second portion of the write buffer in response to receiving a second write command. In some examples, aspects of the operations of 510 may be performed by a data storage component 425 as described with reference to FIG. 4.

At 515, the method may include transferring, from the second portion of the write buffer, the second data to a first set of multiple-level memory cells having sequential physical addresses in accordance with a quantity of data stored to the second portion of the write buffer satisfying a threshold value. In some examples, aspects of the operations of 515 may be performed by a data transfer component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for storing first data to a first portion of a write buffer of the memory system in response to receiving a first write command, where the write buffer includes the first portion that is associated with a first set of sequential logical addresses and a second portion that is associated with a second set of sequential logical addresses; storing second data to the second portion of the write buffer in response to receiving a second write command; and transferring, from the second portion of the write buffer, the second data to a first set of multiple-level memory cells having sequential physical addresses in accordance with a quantity of data stored to the second portion of the write buffer satisfying a threshold value.

Aspect 2: The method, apparatus, or non-transitory computer-readable medium of aspect 1, where the write buffer includes a third portion that is associated with a third set of random logical addresses and the method, apparatuses, and non-transitory computer-readable medium further includes operations, features, circuitry, logic, means, or instructions, or any combination thereof for storing third data to the third portion of the write buffer in response to receiving a third write command, where the third set of random logical addresses includes one or more non-sequential logical addresses.

Aspect 3: The method, apparatus, or non-transitory computer-readable medium of aspect 2, further including operations, features, circuitry, logic, means, or instructions, or any combination thereof for partitioning, by the memory system, the write buffer into a plurality of portions including at least the first portion, the second portion, and the third portion.

Aspect 4: The method, apparatus, or non-transitory computer-readable medium of any of aspects 1 through 3, further including operations, features, circuitry, logic, means, or instructions, or any combination thereof for transferring, from the first portion of the write buffer, the first data to a second set of multiple-level memory cells having sequential physical addresses in accordance with a second quantity of data stored to the first portion of the write buffer satisfying the threshold value.

Aspect 5: The method, apparatus, or non-transitory computer-readable medium of any of aspects 1 through 4, where the threshold value is associated with a storage capacity of the second portion of the write buffer.

Aspect 6: The method, apparatus, or non-transitory computer-readable medium of any of aspects 1 through 5, further including operations, features, circuitry, logic, means, or instructions, or any combination thereof for determining that the first data includes sequential data in response to receiving the first write command, where storing the first data to the first portion is in response to determining that the first data includes sequential data and determining that the second data includes sequential data in response to receiving the second write command, where storing the second data to the second portion is in response to determining that the second data includes sequential data.

Aspect 7: The method, apparatus, or non-transitory computer-readable medium of aspect 6, where determining that the first data includes sequential data is in accordance with the first write command including a bit indicating that the first data includes sequential data and determining that the second data includes sequential data is in accordance with the second write command including a bit indicating that the second data includes sequential data.

Aspect 8: The method, apparatus, or non-transitory computer-readable medium of any of aspects 1 through 7, where the first data is associated with a first application and the second data is associated with a second application different than the first application and the first application and the second application are executed concurrently.

Aspect 9: The method, apparatus, or non-transitory computer-readable medium of any of aspects 1 through 8, where the write buffer includes a plurality of single-level memory cells.

Aspect 10: The method, apparatus, or non-transitory computer-readable medium of any of aspects 1 through 9, where the first set of multiple-level memory cells includes one or more triple-level memory cells.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on (e.g., in response to) the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
store first data to a first portion of a write buffer of the memory system in response to receiving a first write command, wherein the write buffer comprises the first portion that is associated with a first set of sequential logical addresses and a second portion that is associated with a second set of sequential logical addresses;
store second data to the second portion of the write buffer in response to receiving a second write command; and
transfer, from the second portion of the write buffer, the second data to a first set of multiple-level memory cells having sequential physical addresses in accordance with a quantity of data stored to the second portion of the write buffer satisfying a threshold value.

2. The memory system of claim 1, wherein the write buffer comprises a third portion that is associated with a third set of random logical addresses, and the processing circuitry is further configured to cause the memory system to:
store third data to the third portion of the write buffer in response to receiving a third write command, wherein the third set of random logical addresses comprises one or more non-sequential logical addresses.

3. The memory system of claim 2, wherein the processing circuitry is further configured to cause the memory system to:
partition, by the memory system, the write buffer into a plurality of portions comprising at least the first portion, the second portion, and the third portion.

4. The memory system of claim 1, wherein the processing circuitry is further configured to cause the memory system to:
transfer, from the first portion of the write buffer, the first data to a second set of multiple-level memory cells having sequential physical addresses in accordance with a second quantity of data stored to the first portion of the write buffer satisfying the threshold value.

5. The memory system of claim 1, wherein the threshold value is associated with a storage capacity of the second portion of the write buffer.

6. The memory system of claim 1, wherein the processing circuitry is further configured to cause the memory system to:
determine that the first data comprises sequential data in response to receiving the first write command, wherein storing the first data to the first portion is in response to determining that the first data comprises sequential data; and
determine that the second data comprises sequential data in response to receiving the second write command, wherein storing the second data to the second portion is in response to determining that the second data comprises sequential data.

7. The memory system of claim 6, wherein:
determining that the first data comprises sequential data is in accordance with the first write command comprising a bit indicating that the first data comprises sequential data; and
determining that the second data comprises sequential data is in accordance with the second write command comprising a bit indicating that the second data comprises sequential data.

8. The memory system of claim 1, wherein the first data is associated with a first application and the second data is associated with a second application different than the first application, wherein the first application and the second application are executed concurrently.

9. The memory system of claim 1, wherein the write buffer comprises a plurality of single-level memory cells.

10. The memory system of claim 1, wherein the first set of multiple-level memory cells comprises one or more triple-level memory cells.

11. A non-transitory computer-readable medium storing code comprising instructions which, when executed by one or more processors of a memory system, cause the memory system to:
store first data to a first portion of a write buffer of the memory system in response to receiving a first write command, wherein the write buffer comprises the first portion that is associated with a first set of sequential logical addresses and a second portion that is associated with a second set of sequential logical addresses;
store second data to the second portion of the write buffer in response to receiving a second write command; and
transfer, from the second portion of the write buffer, the second data to a first set of multiple-level memory cells having sequential physical addresses in accordance with a quantity of data stored to the second portion of the write buffer satisfying a threshold value.

12. The non-transitory computer-readable medium of claim 11, wherein the write buffer comprises a third portion that is associated with a third set of random logical addresses, and the instructions, when executed by the one or more processors of the memory system, further cause the memory system to:
store third data to the third portion of the write buffer in response to receiving a third write command, wherein the third set of random logical addresses comprises one or more non-sequential logical addresses.

13. The non-transitory computer-readable medium of claim 12, wherein the instructions, when executed by the one or more processors of the memory system, further cause the memory system to:
partition, by the memory system, the write buffer into a plurality of portions comprising at least the first portion, the second portion, and the third portion.

14. The non-transitory computer-readable medium of claim 11, wherein
the instructions, when executed by the one or more processors of the memory system, further cause the memory system to:
transfer, from the first portion of the write buffer, the first data to a second set of multiple-level memory cells having sequential physical addresses in accordance with a second quantity of data stored to the first portion of the write buffer satisfying the threshold value.

15. The non-transitory computer-readable medium of claim 11, wherein the threshold value is associated with a storage capacity of the second portion of the write buffer.

16. The non-transitory computer-readable medium of claim 11, wherein the instructions, when executed by the one or more processors of the memory system, further cause the memory system to:
determine that the first data comprises sequential data in response to receiving the first write command, wherein storing the first data to the first portion is in response to determining that the first data comprises sequential data; and
determine that the second data comprises sequential data in response to receiving the second write command, wherein storing the second data to the second portion is in response to determining that the second data comprises sequential data.

17. The non-transitory computer-readable medium of claim 16, wherein:
determining that the first data comprises sequential data is in accordance with the first write command comprising a bit indicating that the first data comprises sequential data; and
determining that the second data comprises sequential data is in accordance with the second write command comprising a bit indicating that the second data comprises sequential data.

18. The non-transitory computer-readable medium of claim 11, wherein the first data is associated with a first application and the second data is associated with a second application different than the first application, wherein the first application and the second application are executed concurrently.

19. The non-transitory computer-readable medium of claim 11, wherein the write buffer comprises a plurality of single-level memory cells.

20. The non-transitory computer-readable medium of claim 11, wherein the first set of multiple-level memory cells comprises one or more triple-level memory cells.

21. A method by a memory system, comprising:
storing first data to a first portion of a write buffer of the memory system in response to receiving a first write command, wherein the write buffer comprises the first portion that is associated with a first set of sequential logical addresses and a second portion that is associated with a second set of sequential logical addresses;
storing second data to the second portion of the write buffer in response to receiving a second write command; and
transferring, from the second portion of the write buffer, the second data to a first set of multiple-level memory cells having sequential physical addresses in accordance with a quantity of data stored to the second portion of the write buffer satisfying a threshold value.

22. The method of claim 21, wherein the write buffer comprises a third portion that is associated with a third set of random logical addresses, the method further comprising:
storing third data to the third portion of the write buffer in response to receiving a third write command, wherein the third set of random logical addresses comprises one or more non-sequential logical addresses.

23. The method of claim 22, further comprising:
partitioning, by the memory system, the write buffer into a plurality of portions comprising at least the first portion, the second portion, and the third portion.

24. The method of claim 21, further comprising:
transferring, from the first portion of the write buffer, the first data to a second set of multiple-level memory cells having sequential physical addresses in accordance with a second quantity of data stored to the first portion of the write buffer satisfying the threshold value.

25. The method of claim 21, wherein the threshold value is associated with a storage capacity of the second portion of the write buffer.
